(19) United States
(12) Patent Application Publication
(10) Pub. No.: US 2010/0193201 A1
(43) Pub. Date: Aug. 5, 2010

(54) FOAM EXTINGUISHING DEVICE AND METHOD FOR OPERATING IT

(76) Inventor: Andreas Zeller, Neukirchen (AT)

Correspondence Address: RATNERPRESTIA, P.O. BOX 980, VALLEY FORGE, PA, 19482, US

(21) Appl. No.: 11/883,981

(22) PCT Filed: Feb. 1, 2006
(86) PCT No.: PCT/AT06/00039

§ 371 Date: Sep. 19, 2008

(30) Foreign Application Priority Data
Feb. 8, 2005 (AT) A 200/2005

(51) Int. Cl. A62C 2/00

(52) U.S. Cl. 169/46; 169/16

(57) ABSTRACT

The invention describes a foam extinguisher device with an extinguisher water supply unit for an extinguisher water-foaming agent mixture and with a pressurizing gas supply unit with a pressure regulating device for a gaseous medium, in particular compressed air. In a gas injection mechanism, the medium is added to the extinguisher water-foaming agent mixture and then delivered to a discharge mechanism. The pressure regulating device is provided in the form of a pressure reducing valve. Via an adjusting device of a pressure-regulating element, an output pressure of the medium within a pre-selectable differential pressure range is adapted to a pressure level of the flow of extinguisher water prevailing at the adjusting device constituting a reference pressure.

The invention relates to a foam extinguisher device of the type described in the introductory part of claim 1 and a method of operating it as described in the introductory part of claim 19.

Patent specification EP 132 115 A1 discloses a device for admixing a compressed gas with a foam-forming extinguisher liquid. From an extinguisher source containing foam-forming extinguisher liquid, the latter is conveyed through a pipe to a mixing chamber and then to an ejection point by applying pressure to it. A flow meter element and a pressure meter are provided in the conveying direction from the extinguisher source to the mixing chamber, which communicate with a control system. The compressed gas is conveyed via another pipe to the mixing chamber from a source of compressed gas in the form of at least one pressurized gas container, and a shut-off element is disposed in the pipe between the pressurized container and the mixing chamber, followed by a pressure control element, a flow control element and a pressure measuring element. By introducing the compressed gas into the extinguisher liquid in the mixing chamber at a pressure level higher than the pressure level of the extinguisher liquid, a vorticity is created in the mixing chamber resulting in a homogeneous extinguisher agent/gas dispersion, this being achieved by controlling the operating pressure of the gas by means of the pressure regulating element as a function of the through-flow quantity of extinguisher agent, i.e. obtained by measuring and evaluating the flow volumes of the compressed gas and extinguisher agent in the control system.

Another patent specification, EP 0 295 202 A1, discloses a metering device for admixing additives with a flow of water placed under pressure. The foam-forming additive is fed in a desired mixture ratio via a pipe leading into the extinguisher water by means of a metering device. A control valve in the additive pipe is used to maintain the desired mixture ratio, the actuator member of which receives actuation signals from a controller. In order to determine the actual value and generate the actuation signal, the additive is volumetrically measured with an additive measuring device and the mixture is volumetrically measured with a mixture measuring device, and a differential pressure valve is disposed in the additive pipe to ensure that a constant pressure drop can always be maintained in the water-conveying pipe, even if the water pressure fluctuates. In order to maintain a constant foam quality, the process of introducing the additive is controlled as a function of fluctuating pressure conditions as the extinguisher agent is ejected and the resultant control procedures of an extinguisher agent supply unit, e.g. a speed-controlled pump.

The objective of the invention is to propose a foam extinguisher device by means of which a rapid control characteristic can be achieved for adapting the gas pressure level to the pressure level of the extinguisher water in order to maintain a constant extinguisher foam quality in spite of any fluctuation in the pressure level of the extinguisher agent as a function of consumption, as well as a simple system of controlling a pressure difference.

This objective is achieved by the features defined in the characterising part of claim 1. The surprising advantage of this approach is that a pre-selected differential pressure, i.e. an over-pressure, at which the pressurizing gas is delivered to the extinguisher water-foaming agent mixture to create the extinguisher foam is automatically kept constant during operation of the foam extinguisher device as a function of the varying pressure level in the extinguisher water pressurizing line, where the pressure level varies due to changing discharge conditions, as a result of which a foam quality is maintained during operation depending on the selected differential pressure, and the selected differential pressure is adapted, immediately and without delay, by a control operation in the pressure-regulating element if there are fluctuations in the pressure level in the extinguisher water pressurizing line.

Also of advantage is an embodiment defined in claim 2, because the actual pressure level in the extinguisher water pressurizing line is used directly as a control parameter for a control procedure of the pressure-regulating element, as a result of which a fast control characteristic is obtained.

Another embodiment defined in claim 3 is also of advantage because a two-stage pressure reduction takes place and a reduced pressure level is already applied to the pressure-regulating element, thereby resulting in a very finely sensitive differential pressure control.

Also of advantage are embodiments defined in claims 4 and 5, resulting in an automated operating sequence, and specific program sequences can be selected which can also be rapidly adapted to changing conditions of usage.

The advantageous embodiments defined in claims 6 to 8 offer design variants for adapting the foam extinguisher device to specific user requirements.

As a result of the advantageous embodiments defined in claims 9 and 10, the control variables needed to produce an exact differential pressure control are detected in a direct and simple manner.

Also of advantage are the embodiments defined in claims 11 and 12, because a foaming agent is added to the flow of extinguisher water in metered doses as part of the control procedures, thereby enabling the proportion of foaming agent to be controlled.

An embodiment defined in claim 13 is also of advantage because it results in a simplified device and control equipment.

An embodiment defined in claim 14 is of advantage because it results in a mobile control unit which is independent of the site at which the foam extinguisher device is located, which means that the latter can be positioned close to the site of the incident, thereby enabling a user to react to changing conditions more quickly.

Another advantageous embodiment is defined in claim 15, whereby the control and signal transmission system is simplified and a high operating safety is ensured.

Also of advantage are the embodiments defined in claims 16 to 18, offering a comprehensive range of combination options for the design of the foam extinguisher device to suit individual requirements of the user and also adapt to different conditions of usage.

However, the invention also relates to a method of operating the foam extinguisher device proposed by the invention, as defined in claim 19, whereby an automated procedure can be run once the control variables have been pre-set.

Another advantageous feature is defined in claim 20, resulting in an inexpensive variant of the foam extinguisher device.

Claim 21 defines another possible feature, ensuring a broad control spectrum, and the properties of the extinguisher foam can be varied to suit individual applications.

Finally, claim 22 defines another feature, offering the advantage of a more rapid control procedure.

To provide a clearer understanding, the invention will be explained in more detail with reference to examples of embodiments illustrated in the appended drawings.

Of these:

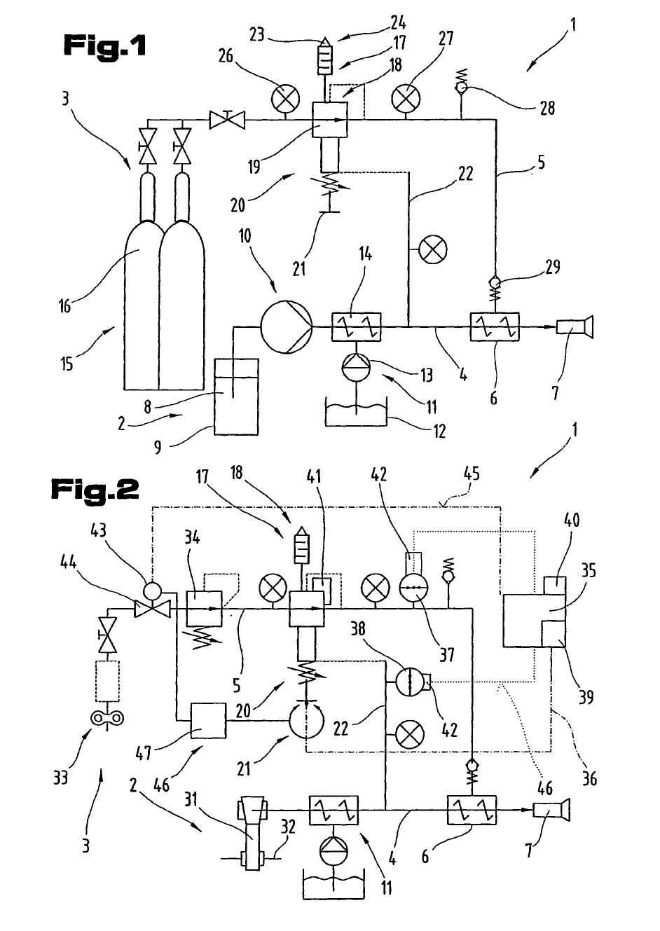

FIG. 1 is a diagram illustrating a foam extinguisher device proposed by the invention;

FIG. 2 is a diagram illustrating a different embodiment of the foam extinguisher device proposed by the invention;

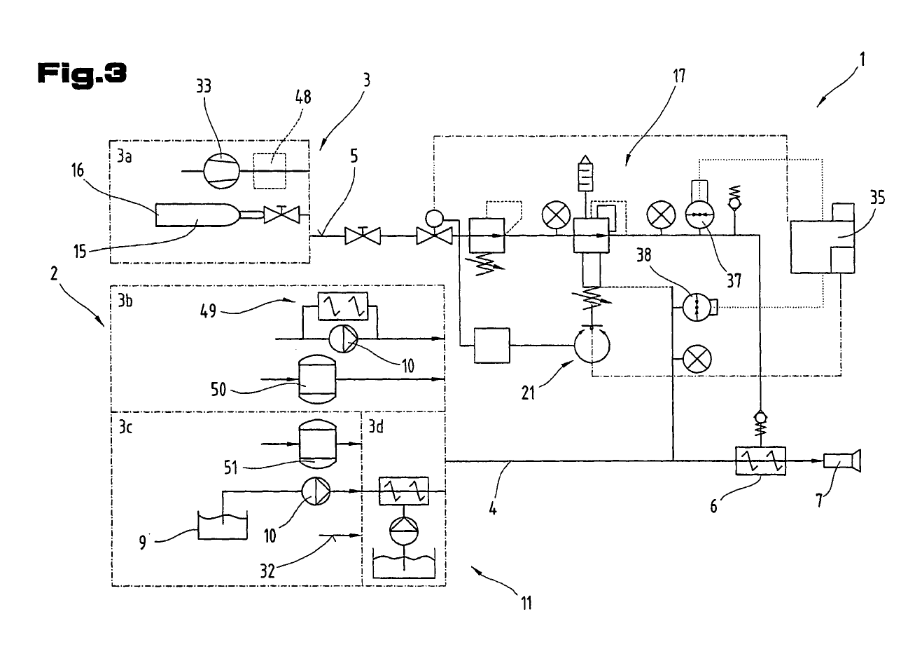

FIG. 3 illustrates possible device combinations of the foam extinguisher device proposed by the invention.

Firstly, it should be pointed out that the same parts described in the different embodiments are denoted by the same reference numbers and the same component names and the disclosures made throughout the description can be transposed in terms of meaning to same parts bearing the same reference numbers or same component names. Furthermore, the positions chosen for the purposes of the description, such as top, bottom, side, etc., relate to the drawing specifically being described and can be transposed in terms of meaning to a new position when another position is being described. Individual features or combinations of features from the different embodiments illustrated and described may be construed as independent inventive solutions or solutions proposed by the invention in their own right.

FIG. 1 is a diagram illustrating one possible embodiment of a foam extinguisher device 1 proposed by the invention. From a functional point of view, it essentially comprises an extinguisher water supply unit 2 and a pressurizing gas supply unit, and an extinguisher water pressurizing line and a gas line opening into a gas injection mechanism 6 to which at least one discharge mechanism 7 is connected.

In the embodiment illustrated as an example, the extinguisher water supply unit 2 comprises a tank 9 containing extinguisher water, a preferably controllable extinguisher water pump 10 and the extinguisher water pressurizing line 4, along the course of which a mixing unit 11 is connected downstream of the extinguisher water pump 10 by means of which an extinguishing agent additive, in particular a foaming agent, is added to a flow of extinguisher water in metered quantities. Such mixing units 11 are metering systems known from the prior art and comprise a container 12 for the extinguishing agent additive, a controllable metering pump 13 and an injection device 14, e.g. nozzle plate, by means of which a uniform distribution of the extinguishing agent additive is produced in the flow of extinguisher water.

The extinguishing agent additive may be metered automatically as a function of various parameters, such as the extinguisher water throughput, in order to produce the required concentrations, but may also be controlled manually if necessary.

The extinguisher water-foaming agent mixture is then fed through the extinguisher water pressurizing line 5 to the gas injection mechanism 6. Here, a gas flow is introduced from the pressurizing gas supply unit 3 at an over-pressure which can be varied within a predefined control range.

In the embodiment illustrated as an example, the pressurizing gas supply unit 3 essentially comprises at least one pressurized gas container 15, e.g. a gas bottle 16 and the gas line 5 delivering a gas flow to the gas injection mechanism 6, and a pressure regulating device 17 with a pressure-regulating element 18 is disposed in the gas line 5 upstream of the gas injection mechanism 6.

As proposed by the invention, the pressure regulating device 17 is a pressure reducing valve 19 with a differential pressure control unit 20 which, in the example illustrated, has a manual adjusting device 21 by means of which a differential pressure can be set within a possible differential pressure range for the discharge pressure of the gaseous medium and for pressurizing the flow of extinguisher water in the gas injection mechanism 6. The pressure regulating device 17 also has a flow connection via a reference pressurizing line 22 to the extinguisher water pressurizing line 4. The pressure in the extinguisher water pressurizing line 4, which varies under the influence of quantity and discharge is thus applied to the differential pressure control unit 20 and therefore constitutes a control variable for the output pressure level of the gas flow in order to keep the pre-set pressure difference more or less constant, i.e. the over-pressure of the gas flow relative to the pressure of the flow of extinguisher water and hence also the properties of the extinguisher foam.

The pressure reducing valve 19 is also provided with a ventilation outlet 23, which is preferably provided with a sound damper 24, to permit a rapid pressure compensation in the gas pressure when the pressure in the extinguisher water pressurizing line 4 is reduced. By preference, pressure indicators 25 are also provided in the gas line 5 upstream and downstream of the pressure-regulating element 18, and the pressure indicator 25 disposed upstream of the pressure-regulating element 18 is a high-pressure manometer 26 and the pressure indicator 25 disposed downstream of the pressure-regulating element 18 is an operating pressure manometer 27. Also disposed in the gas line 5 is a safety valve 7 to prevent any pressure peaks and a check valve 29, preferably disposed immediately upstream of the gas injection mechanism 6, to prevent the extinguisher water-foaming agent mixture from getting into the pressurizing gas supply unit 3.

In the gas injection mechanism 6, which in devices of this type is often also referred to as a mixing chamber, the pressure-reduced gas flow is introduced into the extinguisher water incorporating the extinguishing agent additive, during which the over-pressure of the gas flow can preferably be controlled within a range of between 0 bar and 5 bar.

The properties of the foam ejected from the discharge mechanism 7 for extinguishing purposes, which may be what is referred to as a dry foam or wet foam depending on the requirements in order to achieve an optimum extinguishing effect, can be influenced by the level of over-pressure. In this respect, it should be pointed out that as the over-pressure increases, the foam becomes drier.

FIG. 2 is a diagram illustrating another possible embodiment of a foam extinguisher device 1 proposed by the invention. In this variant, the supply of extinguisher water is taken from an outlet 30, e.g. hydrant 31, via a supply line 32. The extinguisher water is delivered via the extinguisher water pressurizing line 4 and mixing unit 11, as described in connection with in FIG. 1 for example, to the gas injection mechanism 6 and onto the discharge mechanism 7.

The foam extinguisher device 1 also has the pressurizing gas supply unit 2, by means of which a pressurized gas, in particular compressed air, is fed from a compressed air generator 33, e.g. piston compressor, rotary piston compressor, etc., to the extinguisher water-foaming agent mixture in the gas injection mechanism 6 in order to form the foam.

In the embodiment illustrated as an example, the pressurizing gas supply unit 3 is designed to effect a 2-stage pressure reduction. In a first stage, the gas pressure generated by the compressed air generator 33 directly or a via pressure storage, indicated by broken lines, is reduced by a pressure reducing valve 34, which can be set to a pre-selected pressure level, to a pressure level that is slightly higher than a maximum output pressure.

The second pressure reduction stage comprises the pressure regulating device 17 described above in connection with FIG. 1 which, in this example of an embodiment, has a remotely controllable, motor-driven adjusting device 21 which is supplied with power and control signals via a line 36 from a control unit 35.

The pressure-regulating element 18 of the pressure regulating device 17 also communicates via the reference pressure line 22 with the extinguisher water pressurizing line 4, to which a reference pressure manometer 37 serving as a display instrument is connected, for example.

In order to regulate the requisite or a pre-selected gas pressure in the pressurizing gas supply unit 3, a gas pressure sensor 37 is also provided in the gas line 5 running from the pressure-regulating element 18 to the gas injection mechanism 6 and a pressure sensor 38 is disposed in the reference pressure line 22, which constantly detects the actual pressure level in the extinguisher water pressurizing line 4. The gas pressure sensor 37 and the pressure sensor 38 are wired to the control unit 35 via lines 39, 40.

The foam extinguisher device 1 is controlled and automatically regulated by means of the control unit 35 on the basis of control parameters stored in a control program and by selecting the operating status at an input terminal 39 of the control unit 35 using programs which can be pre-selected for different requirements which might occur during deployment and operation of the foam extinguisher device 1.

Accordingly, an automatic sequence control is run and a desired or pre-selected over-pressure of the gas flow relative to the respective actual pressure level in the extinguisher water pressurizing line 4 is established by changing the setting of the pressure-regulating element 18 accordingly by pressurizing the adjusting device 21 via the control unit 35.

The main control parameters are the actual pressure level in the extinguisher water pressurizing line 4 and the gas pressure needed to create a predefined foam property based on this pressure level at which the gas flow must be introduced into the gas injection mechanism 6.

It should also be pointed out that instead of using the lines 36, 39, 40, it would also be possible, within the scope of the invention, for the signal transmission for activating the adjusting device 21 of the pressure-regulating element 18 and running the signal transmission between the gas pressure sensor 37 and pressure sensor 38 and the control unit 35 to take place wirelessly by means of a radio unit, in particular in the short wavelength range, in which case the control unit 35 would be mobile and require no lines, which means that it would also be possible for control procedures to be transmitted directly from the deployment site to the pressure regulating device 17 disposed remotely from it.

To this end, the control unit 35 is equipped with a signal transmitter and receiver device 40 and the adjusting device 21 of the pressure-regulating element 18 is provided with a signal receiver 41 whilst the gas pressure sensor 37 and pressure sensor 38 are provided with signal transmitters 43.

In another, preferred embodiment, it would naturally also be possible for the compressed air generator 33 and a drive 41 of an actuator valve 44 disposed upstream of the pressure regulating device 17 in the gas line 5 to be actuated via a line 45 or also wirelessly.

In the case of a hard-wired system for transmitting control signals, it is recommendable to use a bus system due to the fact that the wiring and control system are less complex and operation is more reliable. An ASi bus system in particular would be suitable for this purpose.

In order to power the drive of the adjusting device 21 and the drive 43 as well as the compressed air generator 33 in one embodiment of the foam extinguisher device 1 based on a wireless signal transmission or bus system, an internal power supply is provided between the actuators and the control unit 35 via a power source 46, e.g. via an accumulator 47, or an external supply from a utility vehicle, for example.

FIG. 3 illustrates the foam extinguisher device 1 with different possible combinations for supplying the gaseous medium and extinguisher water or extinguisher water-foaming agent mixture. The block diagram 3a of FIG. 3 shows various possible ways of feeding the gaseous medium, in particular compressed air, into the gas line 5 with the pressure regulating device 17 of the compressed air generator 33, e.g. a piston compressor, rotary compressed air generator, etc., and also shows another option for the supply via the pressurizing gas container 15, e.g. the gas bottle 16, although it is preferably expedient to opt for a battery of bottles.

In order to keep pressure fluctuations low and avoid constant control procedures in the compressed air generator 33, it is also possible to provide a storage container 48 downstream of the compressed air generator 33—as indicated by broken lines.

FIG. 3 shows the pressure regulating device 17 already described in connection with FIG. 2 as an example, with an automatic differential pressure control system operated via the control unit 35, pressure sensors 37, 38 and motorized adjusting device 21. Instead of this embodiment, it would naturally also be possible to use the manual pressurizing gas supply unit 3 described in connection with FIG. 1.

Other options for supplying the extinguisher water or extinguisher water-foaming agent mixture are illustrated in block diagram 3b of FIG. 3, incorporating the extinguisher water pump 10 and a pre-mixing unit 49 for delivering the foaming agent into the pump outlet line. Another option is to keep the extinguisher water-foaming agent mixture in a pressurized container 50 in the form of a so-called “pre-mix” and deliver it directly to the extinguisher water pressurizing line 4.

Block diagram 3c also shows options incorporating a pressurized water tank 51 or the extinguisher water pump 10 or the pressurized supply line 32. In these instances, the mixing unit 11 for metering a foaming agent is disposed downstream.

Due to the possible combinations for supplying the gaseous medium and the extinguisher water or extinguisher water-foaming agent mixture and the manual or automated pressure regulating device 17, many different requirements of users can be satisfied and the foam extinguisher device 1 proposed by the invention can be set up to suit requirements accordingly.

The embodiments illustrated as examples represent possible design variants of the foam extinguisher device, and it should be pointed out at this stage that the invention is not specifically limited to the design variants specifically illustrated, and instead the individual design variants may be used in different combinations with one another and these possible variations lie within the reach of the person skilled in this technical field given the disclosed technical teaching. Accordingly, all conceivable design variants which can be obtained by combining individual details of the design variants described and illustrated are possible and fall within the scope of the invention.

For the sake of good order, finally, it should be pointed out that, in order to provide a clearer understanding of the structure of the foam extinguisher device, it and its constituent parts are illustrated to a certain extent out of scale and/or on an enlarged scale and/or on a reduced scale. The objective underlying the independent inventive solutions may be found in the description.

Above all, the individual embodiments of the subject matter illustrated in FIGS. 1, 2 and 3 constitute independent solutions proposed by the invention in their own right. The objectives and associated solutions proposed by the invention may be found in the detailed descriptions of these drawings.

List of reference numbers

| | |
|---|---|
| 1 | Foam extinguisher device |
| 2 | Extinguisher water supply unit |
| 3 | Pressurizing gas supply unit |
| 4 | Extinguisher water pressurizing line |
| 5 | Gas line |
| 6 | Gas injection mechanism |
| 7 | Discharge mechanism |
| 8 | Extinguisher water |
| 9 | Tank |
| 10 | Extinguisher water pump |
| 11 | Mixing unit |
| 12 | Container |
| 13 | Metering pump |
| 14 | Injection device |
| 15 | Pressurizing gas container |
| 16 | Gas bottle |
| 17 | Pressure regulating device |
| 18 | Pressure-regulating element |
| 19 | Pressure reducing valve |
| 20 | Differential pressure control unit |
| 21 | Adjusting device |
| 22 | Reference pressure line |
| 23 | Ventilation outlet |
| 24 | Sound damper |
| 25 | Pressure indicators |
| 26 | High-pressure manometer |
| 27 | Operating pressure manometer |
| 28 | Safety valve |
| 29 | Check valve |
| 30 | Outlet |
| 31 | Hydrant |
| 32 | Supply line |
| 33 | Compressed air generator |
| 34 | Pressure reducing valve |
| 35 | Control unit |
| 36 | Line |
| 37 | Gas pressure sensor |
| 38 | Pressure sensor |
| 39 | Input terminal |
| 40 | Signal transmitter and receiver unit |
| 41 | Signal receiver |
| 42 | Signal transmitter |
| 43 | Drive |
| 44 | Actuator valve |
| 45 | Line |
| 46 | Power source |
| 47 | Accumulator |
| 48 | Storage container |
| 49 | Pre-mixing unit |
| 50 | Container |
| 51 | Water tank |

1.-22. (canceled)

23. A foam extinguisher device with an extinguisher water supply unit for an extinguisher water-foaming agent mixture and with a pressurizing gas supply unit with a pressure regulating device for a gaseous medium, and with a gas injection mechanism in which the medium is delivered to the extinguisher water-foaming agent mixture, and with at least one discharge mechanism connected to an outlet of the gas injection mechanism, and the pressure regulating device is provided in the form of a controllable pressure reducing valve, and an output pressure of the medium is adapted within a pre-selectable differential pressure range via an adjusting device of a pressure-regulating element to a pressure level of the flow of extinguisher water prevailing at the adjusting device constituting a reference pressure via a reference pressure line with a flow connection to the extinguisher water pressurizing line, wherein a differential pressure control unit of the pressure control device has an adjustable differential pressure control range of between 0 and 5 bar for an over-pressure of the gas flow relative to the reference pressure of the flow of extinguisher water.

24. The foam extinguisher device according to claim 23, wherein a manually controllable pressure reducing valve is disposed in the gas line upstream of the pressure-regulating element.

25. The foam extinguisher device according to claim 23, wherein the pressure-regulating element has a connection communicating with a control unit.

26. The foam extinguisher device according to claim 25, wherein the control unit is provided in the form of a computer with a data memory and input device.

27. The foam extinguisher device according to claim 23, wherein the adjusting device is designed to be manually settable.

28. The foam extinguisher device according to claim 23, wherein the adjusting device is provided with a motor-driven displacement drive.

29. The foam extinguisher device according to claim 25, wherein the displacement drive is wired to the control unit.

30. The foam extinguisher device according to claim 24, wherein in the extinguisher water pressurizing line and the reference pressure line are provided with pressure sensors wired to the control unit.

31. The foam extinguisher device according to claim 24, wherein in the gas line, a gas pressure sensor wired to the control unit is disposed downstream of the pressure-regulating element.

32. The foam extinguisher device according to claim 23, wherein a foaming agent for forming the extinguisher water-foaming agent mixture is delivered via a mixing unit to a flow of extinguisher water.

33. The foam extinguisher device according to claim 32, wherein the mixing unit and a metering pump of the mixing unit are wired to the control unit.

34. The foam extinguisher device according to claim 23, wherein the extinguisher water-foaming agent mixture is delivered to the extinguisher water supply unit from a pressurized container.

35. The foam extinguisher device according to claim 23, wherein the extinguisher water for the flow of extinguisher water is delivered to the extinguisher water supply unit from a pressurized supply line, or a pressurized water tank, or by conveying it with an extinguisher water pump from a pressureless tank.

36. The foam extinguisher device according to claim 32, wherein a communication connection is provided between the control unit and pressure-regulating element and gas pressure sensor and pressure sensor and mixing unit by means of a bus system, in particular an ASi bus system.

37. The foam extinguisher device according to claim 32, wherein a signal transmission between the control unit and pressure-regulating element and gas pressure sensor and pressure sensor and mixing unit takes place wirelessly.

38. The foam extinguisher device according to claim 35, wherein the foaming agent in a pre-mixing unit disposed upstream of the extinguisher water pump is delivered to the flow of extinguisher water.

39. The foam extinguisher device according to claim 23, wherein the pressurizing gas is supplied from at least one pressurized container.

40. A method of operating a foam extinguisher device according to claim 23, wherein as the extinguisher water-foaming agent mixture circulates through the extinguisher water pressurizing line, the method comprising:
determining a reference pressure value of an actual pressure level in the extinguisher water pressurizing line by a permanent detection system and,
regulating, on the basis of the pressure level determined, a predefined desired pressure of the gas flow delivered to the gas injection mechanism, in a control procedure of the differential pressure control unit of the pressure regulating device to a pressure level of approximately 0 to 5 bar above the pressure level of the actual pressure of the extinguisher water flow using a predefined control matrix or variable control variable in a control unit or a data memory of a computer and/or program module.

41. The method according to claim 40, further comprising selecting the desired pressure of the gas flow delivered to the gas injection mechanism by means of a manual setting at the adjusting device.

42. The method according to claim 40, further comprising reducing the pressure level of the gas flow prior to entering the pressure regulating device in a first pressure reducing stage by means of a pressure reducing valve disposed upstream of the pressure regulating device.

43. The foam extinguisher device according to claim 23, wherein the gaseous medium is compressed air.

44. The foam extinguisher device according to claim 36, wherein the bus system is an ASi bus system.

45. The foam extinguisher device according to claim 39, wherein the at least one pressurized container is a battery of bottles or a compressor.
